(19) United States
(12) Patent Application Publication
(10) Pub. No.: US 2023/0374710 A1
(43) Pub. Date: Nov. 23, 2023

(54) Needled sandwich nonwoven structure, and method of making it

(71) Applicant: Adler Pelzer Holding GmbH, Hagen (DE)

(72) Inventors: Siegfried BERNHARDT, Bremen (DE); Volkmar SCHULZE, Schierling (DE)

(21) Appl. No.: 18/029,452

(22) PCT Filed: Sep. 2, 2021
(86) PCT No.: PCT/EP2021/074312

§ 371 Date: Mar. 30, 2023

(30) Foreign Application Priority Data
Sep. 30, 2020 (DE) 10 2020 125 477.6

(51) Int. Cl. D04H 1/498; D04H 1/413; D04H 1/74; D04H 1/541

(52) U.S. Cl. CPC D04H 1/498; D04H 1/413; D04H 1/74; D04H 1/5418; D10B 2331/04; D10B 2321/022

(57) ABSTRACT

The disclosure provides needled sandwich material structures in which a core nonwoven with vertically oriented fibres is used; and a method of manufacturing these sandwich material structures.

The invention relates to needled sandwich material structures in which a core web with vertically oriented fibres is used; and a method of manufacturing these sandwich material structures.

In the prior art, DE 10 2016 203 348 A1 reports on multilayer acoustic and/or reinforcement nonwovens. Also, in the yet unpublished DE 10 2019 104 847 A1, one finds disclosures on needling of scattering material into needle non-woven structures. The yet unpublished DE 10 2019 104 851 A1 discloses devices for spreading scattering material into needle non-woven structures.

A fibre layer material, which can be used in particular as an artificial leather, and is formed from two types of fibre layers arranged one above the other, which differ with regard to the arrangement of the fibres building them up, is described in DE 2 032 624 A. The fibre layer material is composed of a first layer built up of fibres (short fibre layer), which fibres runt in a predominant proportion essentially in the direction of the layer thickness, and of one or more second fibre layers, which fibres run in a predominant proportion in the surface direction. Both fibre layers are superimposed in a laminate-like manner and bonded to each other, wherein the fibres located in the surface region of the first fibre layer penetrate into the fibre structure of the second fibre layer. The fibre layer material may preferably contain a high polymer elastic substance. The short fibre layer, which fibres run in a predominant proportion substantially in the direction of the layer thickness, is produced by cutting a fibre tape produced in the Rando-Webbers or a cross-laying machine, in the thickness direction in a cutting station into successive fibre pieces; and the fibre pieces are then rotated through 90° in a turning station. Afterwards, fibre taps are fed in on both sides, the layer structure is pressed and needled. Furthermore, the composite is cut in the middle of the short fibre layer and subsequently impregnated with a high-polymer elastic material and subjected to a buffing process. The fibres used have an island-like structure. After impregnation, the layer composite is treated with a solvent to remove the embedding component and dried. Thus, a synthetic leather-like fibre layer material is ultimately obtained.

DE 298 12 401 U1 discloses a fibre composite material for self-supporting moulded parts with high surface stability, in which a Struto nonwoven is laminated on both sides with a further nonwoven. Tao Yang et al, Investigation on Acoustic Behaviour and Air Permeability of Struto Nonwovens; Fibers and Polymers 2016, Vol. 17, No. 12, 2078-2084 describe the acoustic performance of Struto nonwovens and their air permeability.

WO 02/20889 A2, WO 2005/081226 A1, WO 2009/140713 A1 and WO 2010/042993 A1 generally describe absorber material structures with perpendicular fibre orientation and their fabrication.

Vertical fibre orientations are also used as inserts, in particular for seats/seat cushions, see for example WO 2012/019752 A1 and WO 2020/072412 A1.

DE 11 2012 005 205 T5 (see also WO 2013/088828 A1, US 2014/0302285 A1, U.S. Pat. No. 9,321,412 B2) discloses the application of vertical fibre orientations in insulations of floor panels in the automotive industry; US 2017/0008462 A1 describes in particular the application as a partial damping element in this context.

The object of the present invention compared to the aforementioned prior art is thus to provide microperforated needle-punched sandwich nonwoven structures made of a core nonwoven with vertical fibre orientation, in which scattering material is applied between the vertically oriented fibres due to the application and/or properties and this core nonwoven is needle-punched on one or both sides with nonwovens, wovens, knitted fabrics, paper or film. Furthermore, it is the object of the invention to provide a method for the in-line production of such nonwoven structures.

In a first embodiment, it is a subject matter of the present invention to provide a microperforated needled sandwich nonwoven structure 1, having a core nonwoven 2 with vertical fibre orientation, comprising PET and/or PET/PP fibres and bonding fibres of PE, PP and/or BiCo fibre (coPET), wherein the core nonwoven 2 being provided on one or both sides with cover materials 3a, 3b characterised in that the area between the vertically oriented fibres of the core fleece 2 contains interspersed identical or different filling materials 4 of ground material, fibres, flakes and/or powder, wherein the cover materials 3a, 3b are the same or different and each independently comprises a nonwoven, woven, knitted fabric, paper or film.

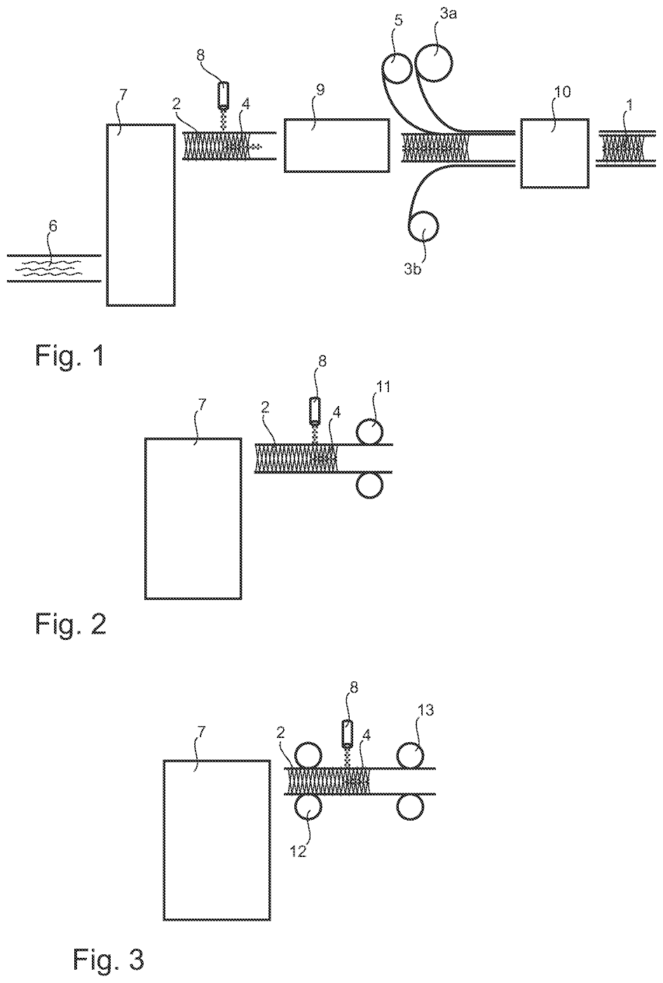

FIG. 1 shows an apparatus for manufacturing the microperforated needle-punched sandwich nonwoven structures 1 according to the invention and their basic manufacturing process. A mechanically or aerodynamically produced nonwoven 6 is fed to the vertical lay-up device 7 and the fibres are erected at an angle of approximately 90° to 45°. The thus “vertically laid” fibres are fed inline to a scattering device 8, which adds filling materials 4 to the fibres, which are held between the aforementioned fibres. The preform thus obtained is then fed to an oven 9 where the structure is thermoset. The composite thus obtained is then provided with a covering material 3a, 3b on one or both sides. In the subsequent needling unit 10, the entire composite is then needled to form the finished end product 1. FIG. 1 also shows the preferred embodiment in which, in addition to the cover materials 3a, 3b, a further film 5 is fed in here on one side between the core nonwoven 2 and the cover materials 3a, 3b. The film 5 is additionally fed—between the cover material 3a, 3b and the core fleece (2)—if acoustic or mechanical properties are to be influenced. If the cover material 3a,3b includes a film, then the additional film 5 is omitted.

FIG. 2 shows a variant of the apparatus according to FIG. 1. Following its passage through the scattering device 8, the non-woven obtained from the vertical lay-up device 7 is fed to a pair of rollers 11 and compressed and spread accordingly. Alternatively, FIG. 3 describes a process variant that comprises two pairs of rollers 12, 13, wherein the pair of rollers 12 is arranged upstream of the scattering device 8 and the pair of rollers 13 is arranged downstream of the scattering device.

No nonwoven structures are known in the prior art that have a vertical fibre orientation based on mechanical or aerodynamic nonwoven formation with needled cover webs, films or papers on one or both sides. Furthermore, there are no disclosures on the interspersing of different scattering materials between the vertical fibre orientations. Processes and plants for the production of such nonwoven structures are also not known.

In addition to covering the core nonwoven 2 on one side, it is also preferred to cover it on both sides with the above-mentioned cover materials 3a,3b. These can be the same or different, have different materials, different thicknesses, different densities, different flow resistances (air permeability), etc.

In a further embodiment, a film 5 is furthermore located on one or both sides between the core nonwoven 2 with vertical fibre orientation and the cover materials 3a, 3b; which is also microperforated by the needling of the overall composite. Materials of the film(s) include in particular PE/PA/PE and PA/PE. Pure PE films are also used. The films 5 essentially have a thickness in the range of 40 μm to 180 μm. If only one film fleece (PE/PA/PE+PET) is used as cover material (3a,b), thicknesses up to 450 μm are preferred. The weight per unit area of the nonwovens 3a,3b is preferably in the range of 60 to 450 g/m².

A method according to the invention for the production of microperforated needle-punched sandwich nonwoven structures 1 (see FIG. 1), which makes it possible to feed a cover material 3a,3b in-line to a core nonwoven 2 with vertical fibre orientation at least on one side and to needle-punch the overall composite, is characterised in that

the fibres of a mechanically or aerodynamically formed nonwoven 6 are oriented in a vertical lay-up device 7 in the range of predominantly 90° and 45°,
spreads the oriented fibres/fibre layers,
by means of scattering device 8 scatters filling materials 4 between the vertically oriented fibres,
the structure obtained is thermoset in an oven 9,
after solidification, cover materials 3a, 3b are fed in on one or both sides and
needle the obtained composite in a needling unit 10.

It is advantageous if the oven 9 is equipped with two conveyor belts and two separate drives. By using different speeds of the upper and lower belt, the tightness of the oriented fibres/fibre layers can be adjusted independently of each other.

Furthermore, it is advantageous if different temperatures (top and bottom) can be set in the oven in the range of preferably 120 to 180° C., for example by means of special hot air slot nozzles transverse to the throughput direction, which can be controlled separately if necessary. In particular, it is advantageous that one can thus influence the properties of the fibre/scatter composite via the thickness.

The focus here is mainly on the cross-linking of the materials, namely the influence of the mechanical properties stiffness, strength and the processing behaviour in subsequent processes.

The spreading of the vertically (90°) to 45° oriented fibres/fibre layers is done, for example, by arranging a pair of rollers 11 in the direction of travel behind the scattering device 8, i.e. between the scattering device 8 and the oven 9 (see FIG. 2). The speed of the roller pair 11 can be variably adjusted and can be greater than the operating speed of the vertical lay-up device 7.

It is also possible to work with two pairs of rollers 12, 13. One pair of rollers 12 is arranged upstream of the scattering device 8 and one pair of rollers 13 is arranged downstream of the scattering device (upstream of the oven 9) (see FIG. 3). Both roller pairs 12 and 13 can be controlled separately.

Essential elements of the present invention are a micro-perforated needle-punched sandwich nonwoven structure in which acoustic, mechanical and processing properties are achieved, on the one hand, by scattering property-influencing scattering material into vertically oriented fibres and, on the other hand, the process of needle-punching this structure on one or both sides with nonwovens, wovens, knitted fabrics, paper or film. Furthermore, the in-line process for the production of such sandwich nonwoven structures, in particular by means of the integrated scattering plant, and precisely the scattering of scattering material into vertical fibre orientations, represents a novelty in the plant sector.

The advantage of the present invention lies in particular in the in-line production of micro-perforated needle-punched sandwich nonwoven structures with (in the core) vertical fibre orientation; in that, on the one hand, the acoustic, mechanical and processing properties of the nonwoven (and thus ultimately the component properties) can be influenced by the fibre orientation, the fibre mix, the fibre fineness of the core nonwoven and the scattering material contained therein and, on the other hand, by needling this scatter-filled core nonwoven formed with vertically oriented fibres with nonwovens, wovens, knitted fabrics, paper or film and thus provide new, property-optimised sandwich nonwoven structures.

The following materials, among others, are used as scattering material between the vertically oriented fibres of the core nonwoven with vertical fibre orientation, which influence the following properties:

Acoustics: Hollow fibres with different cross-sectional geometry, GF/BiCo/PET ground/fibrous material, foam flakes;
Water absorption: hydrophobised fibres (inter alia H-PET), GF/PP/BiCo ground/fibrous material;
Stone chipping: PP/PE ground/fibrous material;
Ice accumulation/adhesion: hydrophobised fibres (inter alia H-PET), PP/PET ground material;
Stiffness: carbon fibres, natural fibres;
Temperature resistance: PP/GF ground/fibre material, mineral fibres, glass fibres (GF);
Burning behaviour: GF/Panox/PET/BiCo ground/fibrous material, flame retardant, flame retardant treated fibre, mineral fibres, glass fibres;
Tear resistance: Aramid fibres.

The sandwich nonwoven structures according to the present invention are microperforated by needling. Microperforation in the sense of the present invention is defined by hole diameters in the range of 0.05 to 2.4 mm.

### EXAMPLE OF EXECUTION

### Example 1

According to the method of the invention, a commercial 500 g/m² nonwoven 2 with vertically oriented fibres (65% PET/35% coPET) was interspersed with 50 g/m² 75% PP/25% PE ground/fibrous material 4, which was needled on both sides with an 80 g/m² needled nonwoven (75% PET/25% PP) 3.

After forming into a wheel arch liner, comparative tests were made with a conventional wheel arch liner made with conventional nonwoven (800 g/m² 40% PP/30% PET/30% BiCo). Significant differences were found with regard to bending stiffness (10% increase), stone impact resistance (in shot through and weight loss) and deformation behaviour.

### Example 2

According to the method of the invention,

a 1300 g/m² nonwoven with vertically oriented fibres
(70% PET/30% coPET) 2, 100 g/m² 40%PP/30%PET/30% BiCo-ground material 4 was interspersed and then needle-punched on both sides with 150 g/m² needled nonwoven (75% PET/25% PP) 3. Here, too, a significant improvement in the mechanical properties was seen after forming into an underbody shield, compared to the conventional underbody shield material structures.

### LIST OF REFERENCE SIGNS

1 sandwich nonwoven structure
2 core nonwoven
3a,3b cover material
4 filling material
film
6 nonwoven
7 vertical lay-up device
8 scattering device
9 oven
needling unit
11 pair of rollers
12 pair of rollers
13 pair of rollers

1. A micro-perforated needle-punched sandwich nonwoven structure,
having a core nonwoven with vertical fibre orientation, com-prising PET and/or PET/PP fibres and bonding fibres of PE, PP and/or BiCo fibre (coPET), wherein the core nonwoven being provided on one or both sides with cover materials
wherein
the area between the vertically oriented fibres of the core nonwoven contains interspersed identical or different filling materials of ground material, fibres, flakes and/or powder,
wherein
the cover materials are the same or different and each independently of each other comprises a nonwoven, woven, knitted fabric, paper or film.

2. The sandwich nonwoven structure according to claim 1,
comprising a film between the core nonwoven and the cover materials.

3. A method of manufacturing sandwich nonwoven structures according to claim 1, wherein the fibres of a mechanically or aerodynamically formed nonwoven are oriented in-line in a vertical lay-up device in the range of predominantly 90° and 45°,
spreads the oriented fibres/fibre layers,
by a scattering device, filler materials are scattered between the vertically oriented fibres,
the structure obtained is thermoset in an oven,
after solidification, cover materials are fed in on one or both sides and
needling the obtained composite in a needling unit.

4. The method according to claim 3, wherein
comprising spreading the vertically oriented fibres of the core nonwoven by pairs of rollers, which
(a) before and after the scattering device or
(b) are arranged after the scattering device by a pair of roll-ers,
wherein the pairs of rollers are controlled separately, if necessary.

5. A method of manufacturing sandwich nonwoven structures according to claim 2, wherein the fibres of a mechanically or aerodynamically formed nonwoven are oriented in-line in a vertical lay-up device in the range of predominantly 90° and 45°,
spreads the oriented fibres/fibre layers,
by a scattering device, filler materials are scattered between the vertically oriented fibres,
the structure obtained is thermoset in an oven,
after solidification, cover materials are fed in on one or both sides and
needling the obtained composite in a needling unit.

6. The method according to claim 5, wherein
comprising spreading the vertically oriented fibres of the core nonwoven by pairs of rollers, which
(a) before and after the scattering device or
(b) are arranged after the scattering device by a pair of rollers,
wherein the pairs of rollers are controlled separately, if necessary.
